(19) United States
(12) Patent Application Publication
(10) Pub. No.: US 2026/0128205 A1
(43) Pub. Date: May 7, 2026

(54) MAGNETIC COMPONENT

(71) Applicant: CYNTEC CO., LTD., Hsinchu (TW)

(72) Inventors: Yu-Cheng Lai, Hsinchu (TW); Po-Chun Sun, Hsinchu (TW); Yi-Min Hsieh, Hsinchu (TW); Shao-Wei Chang, Hsinchu (TW); Chun-Hung Lee, Hsinchu (TW); Chun-Ying Liao, Hsinchu (TW)

(73) Assignee: CYNTEC CO., LTD., Hsinchu (TW)

(21) Appl. No.: 19/375,268

(22) Filed: Oct. 31, 2025

Related U.S. Application Data
(60) Provisional application No. 63/716,703, filed on Nov. 5, 2024.

(51) Int. Cl. H01F 27/28; H01F 27/24

(52) U.S. Cl. CPC H01F 27/28; H01F 27/24; H01F 27/263

(57) ABSTRACT

A magnetic component includes a primary winding, a secondary winding and at least one tertiary winding stacked with each other to form a symmetrical inductance structure or an asymmetrical inductance structure. Through the relationship of the distances between the primary winding, the secondary winding and the at least one tertiary winding of the symmetrical inductance structure, the leakage inductance can be balanced, the tolerance can be stabilized, the reverse current can be eliminated, the AC loss of the tertiary winding can be reduced, and/or the total loss can be reduced. Through the relationship of the distances between the primary winding, the secondary winding and the at least one tertiary winding of the asymmetrical inductance structure, the leakage inductance can be adjusted more flexibly, the tolerance can be stabilized, and the couple energy can be reduced.

### CROSS REFERENCE TO RELATED APPLICATIONS

This application claims the benefit of U.S. Provisional Application No. 63/716,703, filed on Nov. 5, 2024. The content of the application is incorporated herein by reference.

### BACKGROUND OF THE INVENTION

### 1. Field of the Invention

The invention relates to a magnetic component and, more particularly, to a magnetic component capable of adjusting leakage inductance.

### 2. Description of the Related Art

A transformer is an important magnetic component used for increasing or decreasing voltage. In most of circuits, there is always a transformer installed therein. In a multi-port charger, the electromagnetic coupling and voltage stability between the ports of the multi-port charger are closely related to leakage inductance of the transformer. Leakage inductance determines the quality of energy coupling and the degree of interference between the ports of the multi-port charger. Thus, how to adjust leakage inductance of the transformer for the multi-port charger has become a significant design issue.

### SUMMARY OF THE INVENTION

The invention provides a magnetic component capable of adjusting leakage inductance, so as to solve the aforesaid problems.

According to an embodiment of the invention, a magnetic component comprises a core, a primary winding, a secondary winding, a magnetic member, a first tertiary winding and a second tertiary winding. The primary winding is disposed in the core. The secondary winding is disposed in the core. The magnetic member is disposed between the primary winding and the secondary winding. The first tertiary winding is disposed outside the primary winding. The second tertiary winding is disposed outside the secondary winding. The secondary winding is apart from the second tertiary winding by a first distance d1, the secondary winding is apart from the first tertiary winding by a second distance d2, the primary winding is apart from the first tertiary winding by a third distance d3, and the primary winding is apart from the second tertiary winding by a fourth distance d4. The first distance d1, the second distance d2, the third distance d3 and the fourth distance d4 satisfy a relationship as follows:

$$0.8 < \frac{d 1 + d 2}{d 3 + d 4} < 1.2 .$$

In an embodiment, the core has an inner leg. The primary winding, the secondary winding, the first tertiary winding and the second tertiary winding are disposed at different positions along a length direction of the inner leg without overlapping.

In an embodiment, a number of turns of each of the first tertiary winding and the second tertiary winding is less than a number of turns of each of the primary winding and the secondary winding.

In an embodiment, the number of turns of each of the first tertiary winding and the second tertiary winding is less than ½ of the number of turns of each of the primary winding and the secondary winding.

In an embodiment, at least one of the primary winding, the secondary winding, the first tertiary winding and the second tertiary winding is wound by a multi-stranded insulated wire.

In an embodiment, the multi-stranded insulated wire comprises a plurality of stranded wire layers, each of the plurality of stranded wire layers is covered by a first insulation layer, a first stranded wire layer of the plurality of stranded wire layers comprises a plurality of strands, and each of the plurality of strands is covered by a second insulation layer.

In an embodiment, any of the primary winding, the secondary winding, the first tertiary winding and the second tertiary winding is a Litz wire or a copper sheet.

In an embodiment, the core comprises an I-core, a first U-core and a second U-core, the first U-core and the second U-core are arranged side by side to provide an inner leg, a heat dissipation material is filled in a gap of the inner leg, and the I-core is disposed on the first U-core and the second U-core.

In an embodiment, the core has an inner leg and at least two outer legs; wherein the primary winding, the secondary winding, the first tertiary winding and the second tertiary winding are wound around the inner leg.

In an embodiment, the magnetic component further comprises a casing, a thermal conductive filler and an electric conductive member. The core is disposed in the casing. The thermal conductive filler is filled into the casing. The thermal conductive filler covers at least a part of an inner leg of the core and at least a part of the primary winding, the secondary winding, the first tertiary winding and the second tertiary winding. The electric conductive member is disposed above an opening of the core and the casing. The electric conductive member comprises two conductive metals covered by an insulation material. The first tertiary winding and the second tertiary winding are connected to the electric conductive member, and a part of the electric conductive member is bent into the thermal conductive filler.

In an embodiment, the two conductive metals are oppositely disposed at two sides of the core and are not in contact with the core and the casing. Two bending structures of the two conductive metals located outside the core extend to the thermal conductive filler, and the two bending structures are not in contact with the core and do not extend to a bottom of the casing.

In an embodiment, the magnetic component further comprises a casing, a thermal conductive filler and an electric conductive member. The core is disposed in the casing. The thermal conductive filler is filled into the casing. The thermal conductive filler covers at least a part of an inner leg of the core and at least a part of the primary winding, the secondary winding, the first tertiary winding and the second tertiary winding. The electric conductive member is disposed beside the core. The electric conductive member comprises two conductive metals covered by an insulation material. The first tertiary winding and the second tertiary winding are connected to the electric conductive member, and a part of the electric conductive member is covered by the thermal conductive filler.

In an embodiment, the two conductive metals are disposed side by side at a side of the core and are not in contact with the core. Two bending structures of the two conductive metals located outside the core extend to the thermal conductive filler and are not in contact with the core. The first tertiary winding and the second tertiary winding extend to a bottom of the casing and are connected to a plurality of engaging holes of the two conductive metals, such that the first tertiary winding and the second tertiary winding are connected in parallel. Two horizontal structures of the two conductive metals extend out of the insulation material to form two electrodes for the first tertiary winding and the second tertiary winding. An insulation member is disposed at the bottom of the casing and the plurality of engaging holes of the two conductive metals are disposed in an accommodating space of the insulation member.

According to another embodiment of the invention, a magnetic component comprises a core, a primary winding, a secondary winding and a tertiary winding. The primary winding is disposed in the core. The secondary winding is disposed in the core. The tertiary winding is disposed between the primary winding and the secondary winding. The secondary winding is apart from the tertiary winding by a first distance d1, and the primary winding is apart from the tertiary winding by a second distance d2. The first distance d1 and the second distance d2 satisfy a relationship as follows:

$$0.8 < \frac{d 2}{d 1} < 1.2 .$$

In an embodiment, the core has an inner leg. The primary winding, the secondary winding and the tertiary winding are disposed at different positions along a length direction of the inner leg without overlapping.

In an embodiment, a number of turns of the tertiary winding is less than a number of turns of each of the primary winding and the secondary winding.

In an embodiment, the number of turns of the tertiary winding is less than ½ of the number of turns of each of the primary winding and the secondary winding.

In an embodiment, at least one of the primary winding, the secondary winding and the tertiary winding is wound by a multi-stranded insulated wire.

In an embodiment, the multi-stranded insulated wire comprises a plurality of stranded wire layers, each of the plurality of stranded wire layers is covered by a first insulation layer, a first stranded wire layer of the plurality of stranded wire layers comprises a plurality of strands, and each of the plurality of strands is covered by a second insulation layer.

In an embodiment, any of the primary winding, the secondary winding and the tertiary winding is a Litz wire or a copper sheet.

In an embodiment, the core comprises an I-core, a first U-core and a second U-core, the first U-core and the second U-core are arranged side by side to provide an inner leg, a heat dissipation material is filled in a gap of the inner leg, and the I-core is disposed on the first U-core and the second U-core.

In an embodiment, the core has an inner leg and at least two outer legs; wherein the primary winding, the secondary winding and the tertiary winding are wound around the inner leg.

In an embodiment, the magnetic component further comprises a casing, a thermal conductive filler and an electric conductive member. The core is disposed in the casing. The thermal conductive filler is filled into the casing. The electric conductive member is disposed above an opening of the core and the casing. The tertiary winding is connected to the electric conductive member, and a part of the electric conductive member is bent into the thermal conductive filler.

In an embodiment, the magnetic component further comprises a casing, a thermal conductive filler and an electric conductive member. The core is disposed in the casing. The thermal conductive filler is filled into the casing. The electric conductive member is disposed beside the core. The tertiary winding is connected to the electric conductive member, and a part of the electric conductive member is covered by the thermal conductive filler.

According to another embodiment of the invention, a magnetic component comprises a core, a primary winding, a tertiary winding, a secondary winding and a magnetic member. The primary winding is disposed in the core. The tertiary winding is disposed in the core. The secondary winding is disposed between the primary winding and the tertiary winding. The magnetic member is disposed between the secondary winding and the tertiary winding. The secondary winding is apart from the tertiary winding by a first distance d1, and the primary winding is apart from the tertiary winding by a second distance d2. The first distance d1 and the second distance d2 satisfy a relationship as follows:

$$0 < \frac{d 1}{d 2} < 1.2 .$$

In an embodiment, the core has an inner leg; wherein the primary winding, the secondary winding and the tertiary winding are disposed at different positions along a length direction of the inner leg without overlapping.

In an embodiment, a number of turns of the tertiary winding is less than a number of turns of each of the primary winding and the secondary winding.

As mentioned in the above, in an embodiment, the magnetic member may be disposed between the primary winding and the secondary winding, and the first tertiary winding and the second tertiary winding may be disposed outside the primary winding and the secondary winding, so as to form a symmetrical inductance structure. Through the relationship of the distances between the primary winding, the secondary winding, the first tertiary winding and the second tertiary winding

$$( i . e . 0.8 < \frac{d 1 + d 2}{d 3 + d 4} < 1 \text{.2} ) ,$$

the leakage inductance can be balanced, the tolerance can be stabilized, and the total loss can be reduced. In another embodiment, the tertiary winding may be disposed between the primary winding and the secondary winding to form a symmetrical inductance structure. Through the relationship of the distances between the primary winding, the secondary winding and the tertiary winding

$$( i . e . 0.8 < \frac{d 2}{d 1} < 1.2 ) ,$$

the reverse current can be eliminated, the AC loss of the tertiary winding can be reduced, and the total loss can be reduced. In another embodiment, the secondary winding may be disposed between the primary winding and the tertiary winding, and the magnetic member may be disposed between the secondary winding and the tertiary winding, so as to form an asymmetrical inductance structure. Through the relationship of the distances between the primary winding, the secondary winding and the tertiary winding

$$( i . e . 0 < \frac{d 1}{d 2} < 1 \text{.2} ) ,$$

the leakage inductance can be adjusted more flexibly, the tolerance can be stabilized, and the couple energy can be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a magnetic component according to an embodiment of the invention.

FIG. 2 is an exploded view illustrating the magnetic component shown in FIG. 1.

FIG. 3 is a sectional view illustrating the magnetic component shown in FIG. 1.

FIG. 4 is a schematic view of a multi-stranded insulated wire according to an embodiment of the invention.

FIG. 5 is a perspective view illustrating the magnetic component according to another embodiment of the invention.

FIG. 6 is an exploded view illustrating the magnetic component shown in FIG. 5.

FIG. 7 is a sectional view illustrating the magnetic component shown in FIG. 5.

FIG. 8 is a perspective view illustrating the magnetic component according to another embodiment of the invention.

FIG. 9 is an exploded view illustrating the magnetic component shown in FIG. 8.

FIG. 10 is a perspective view of partial components shown in FIG. 9 from another viewing angle.

FIG. 11 is a sectional view illustrating the magnetic component shown in FIG. 8.

FIG. 12 is a perspective view illustrating a magnetic component according to another embodiment of the invention.

FIG. 13 is an exploded view illustrating the magnetic component shown in FIG. 12.

FIG. 14 is a sectional view illustrating the magnetic component shown in FIG. 12.

FIG. 15 is a perspective view illustrating a magnetic component according to another embodiment of the invention.

FIG. 16 is an exploded view illustrating the magnetic component shown in FIG. 15.

FIG. 17 is a sectional view illustrating the magnetic component shown in FIG. 15.

### DETAILED DESCRIPTION

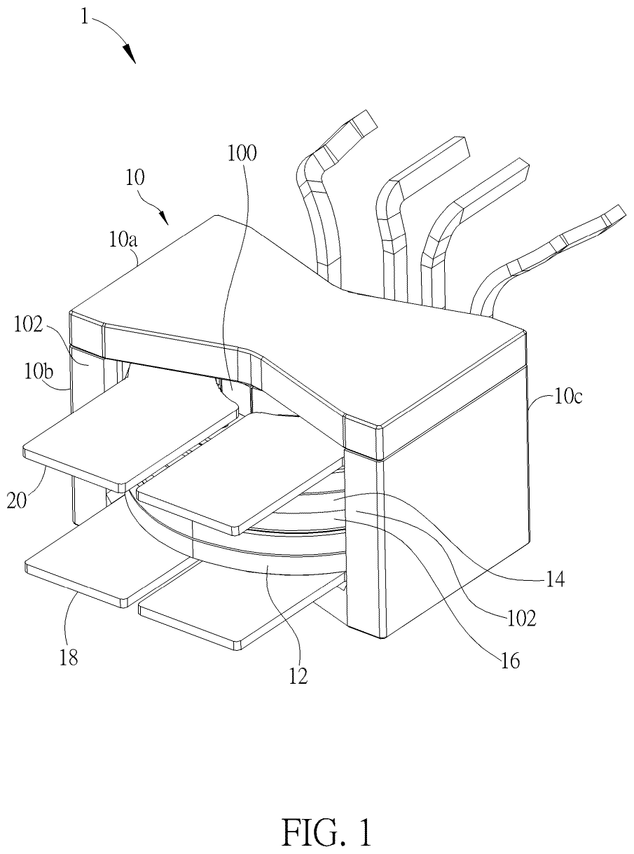

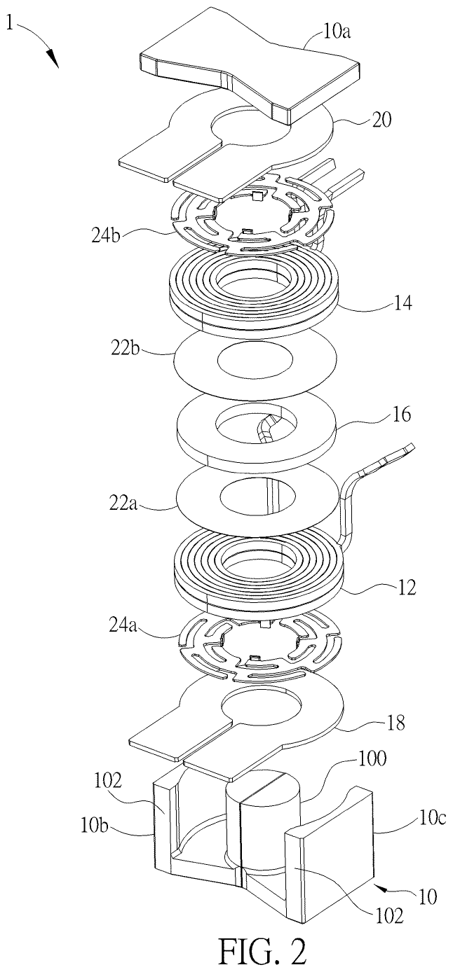

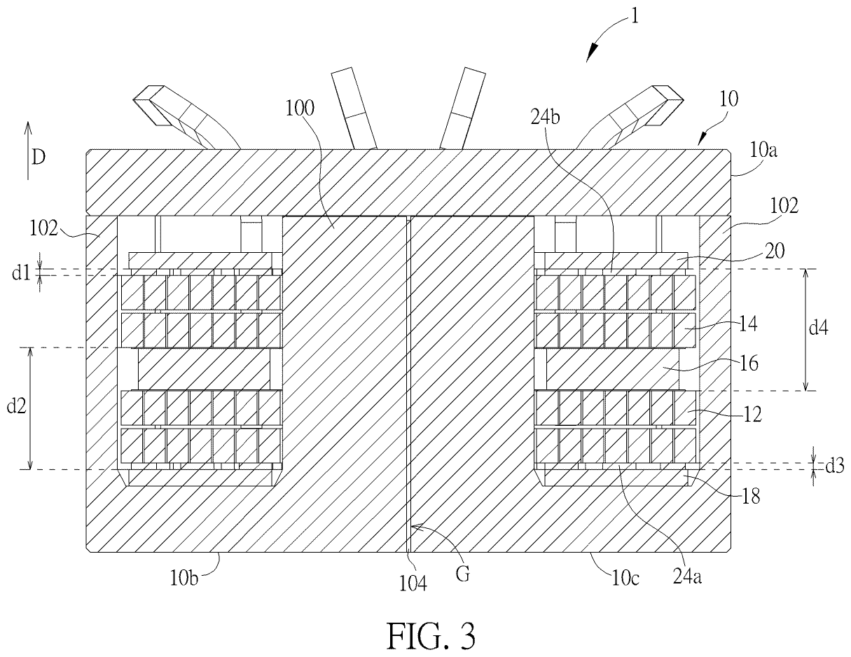

Referring to FIGS. 1 to 3, FIG. 1 is a perspective view illustrating a magnetic component 1 according to an embodiment of the invention, FIG. 2 is an exploded view illustrating the magnetic component 1 shown in FIG. 1, and FIG. 3 is a sectional view illustrating the magnetic component 1 shown in FIG. 1.

The magnetic component 1 of the invention may be a transformer or other magnetic components. As shown in FIGS. 1 to 3, the magnetic component 1 comprises a core 10, a primary winding 12, a secondary winding 14, a magnetic member 16, a first tertiary winding 18, a second tertiary winding 20, two insulation sheets 22a, 22b and two bobbins 24a, 24b. The primary winding 12, the secondary winding 14, the magnetic member 16, the first tertiary winding 18, the second tertiary winding 20, the two insulation sheets 22a, 22b and the two bobbins 24a, 24b are disposed in the core 10. In this embodiment, the core 10 may have an inner leg 100 and at least two outer legs 102. The primary winding 12, the secondary winding 14, the first tertiary winding 18 and the second tertiary winding 20 are wound around the inner leg 100.

The magnetic member 16 is disposed between the primary winding 12 and the secondary winding 14, wherein the insulation sheet 22a is disposed between the primary winding 12 and the magnetic member 16, and the insulation sheet 22b is disposed between the secondary winding 14 and the magnetic member 16. In this embodiment, the magnetic member 16 may be, but is not limited to, a magnetic shunt. The first tertiary winding 18 is disposed outside the primary winding 12, wherein the bobbin 24a is disposed between the primary winding 12 and the first tertiary winding 18. The second tertiary winding 20 is disposed outside the secondary winding 14, wherein the bobbin 24b is disposed between the secondary winding 14 and the second tertiary winding 20. The magnetic component 1 is assembled by sequentially disposing the first tertiary winding 18, the bobbin 24a, the primary winding 12, the insulation sheet 22a, the magnetic member 16, the insulation sheet 22b, the secondary winding 14, the bobbin 24b and the second tertiary winding 20 around the inner leg 100 of the core 10, so as to form a symmetrical inductance structure. Furthermore, the first tertiary winding 18 and the second tertiary winding 20 are electrically connected in parallel.

As shown in FIG. 3, the primary winding 12, the secondary winding 14, the first tertiary winding 18 and the second tertiary winding 20 may be disposed at different positions along a length direction D of the inner leg 100 without overlapping, such that each of the primary winding 12, the secondary winding 14, the first tertiary winding 18 and the second tertiary winding 20 may have a large leakage inductance.

In this embodiment, the secondary winding 14 is apart from the second tertiary winding 20 by a first distance d1, the secondary winding 14 is apart from the first tertiary winding 18 by a second distance d2, the primary winding 12 is apart from the first tertiary winding 18 by a third distance d3, and the primary winding 12 is apart from the second tertiary winding 20 by a fourth distance d4. The first distance d1, the second distance d2, the third distance d3 and the fourth distance d4 satisfy a relationship as follows:

$$0.8 < \frac{d 1 + d 2}{d 3 + d 4} < 1.2 .$$

Through the relationship of the distances d1-d4 between the primary winding 12, the secondary winding 14, the first tertiary winding 18 and the second tertiary winding 20

$$( i . e . 0.8 < \frac{d 1 + d 2}{d 3 + d 4} < 1 \text{.2} ) ,$$

the leakage inductance can be balanced and the tolerance can be stabilized. Furthermore, the leakage inductance error may be less than 15%, i.e. (L1−L2)/L1*100%<15%, wherein L1 represents the leakage inductance of the primary winding 12 and L2 represents the leakage inductance of the secondary winding 14. When the magnetic component 1 is applied to a multi-port charger, the magnetic component 1 can achieve zero voltage switching (ZVS) in both charging mode and discharging mode of the multi-port charger, such that the total loss can be reduced.

In this embodiment, a number of turns of each of the first tertiary winding 18 and the second tertiary winding 20 may be less than a number of turns of each of the primary winding 12 and the secondary winding 14. Preferably, the number of turns of each of the first tertiary winding 18 and the second tertiary winding 20 may be less than ½ of the number of turns of each of the primary winding 12 and the secondary winding 14.

In this embodiment, any of the primary winding 12, the secondary winding 14, the first tertiary winding 18 and the second tertiary winding 20 may be a Litz wire or a copper sheet. For example, as shown in FIG. 2, the primary winding 12 and the secondary winding 14 may be Litz wires, and the first tertiary winding 18 and the second tertiary winding 20 may be copper sheets, but the invention is not so limited. In general, the copper sheet has low DC loss and high AC loss, such that the magnetic component 1 with the copper sheet may be prone to heat generation due to high AC loss. Thus, the first tertiary winding 18 and the second tertiary winding 20 may be made of Litz wires to reduce AC loss.

In this embodiment, the core 10 may comprise an I-core 10a, a first U-core 10b and a second U-core 10c, as shown in FIG. 3. The first U-core 10b and the second U-core 10c are arranged side by side to provide the inner leg 100, wherein the inner leg 100 has a gap G. Furthermore, two outer legs 102 are provided by the first U-core 10b and the second U-core 10c respectively and located at opposite sides. The I-core 10a is disposed on the first U-core 10b and the second U-core 10c. A heat dissipation material 104 is filled in the gap G of the inner leg 100 to improve heat dissipation. The core 10 consisting of the I-core 10a, the first U-core 10b and the second U-core 10c can help dissipate heat and reduce core stress, so as to achieve high power density component.

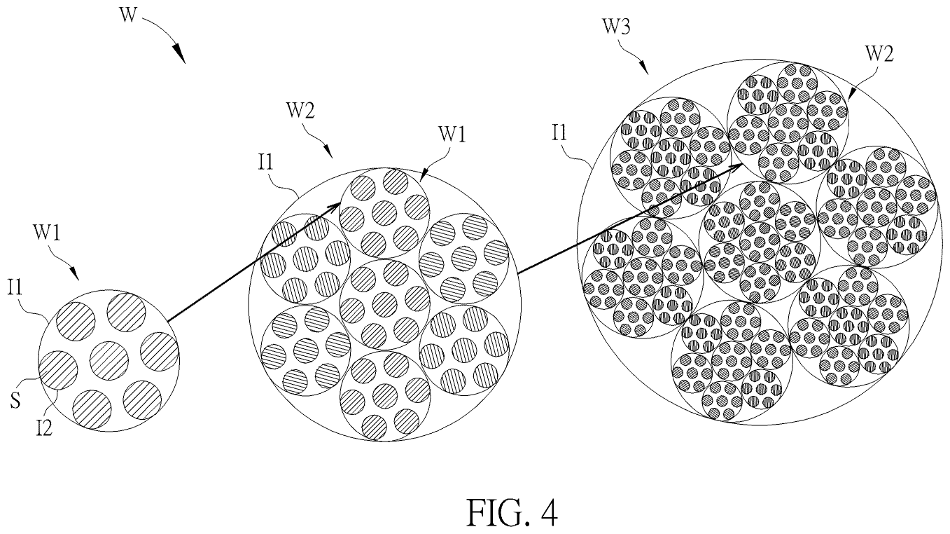

Referring to FIG. 4, FIG. 4 is a schematic view of a multi-stranded insulated wire W according to an embodiment of the invention.

In this embodiment, at least one of the primary winding 12, the secondary winding 14, the first tertiary winding 18 and the second tertiary winding 20 may be wound by a multi-stranded insulated wire W, as shown in FIG. 4. The multi-stranded insulated wire W may comprise a plurality of stranded wire layers W1, W2, W3 and each of the plurality of stranded wire layers W1, W2, W3 may be covered by a first insulation layer I1. As shown in FIG. 4, the multi-stranded insulated wire W may comprise three stranded wire layers W1, W2, W3. The first stranded wire layer W1 may comprise a plurality of strands S covered by the first insulation layer I1, wherein the plurality of strands S are twisted together to form the first stranded wire layer W1. The second stranded wire layer W2 may comprise a plurality of bundles of the first stranded wire layers W1 covered by the first insulation layer I1, wherein the plurality of bundles of the first stranded wire layers W1 are twisted together to form the second stranded wire layer W2. The third stranded wire layer W3 may comprise a plurality of bundles of the second stranded wire layers W2 covered by the first insulation layer I1, wherein the plurality of bundles of the second stranded wire layers W2 are twisted together to form the third stranded wire layer W3. Accordingly, the stranded wire layers W1, W2, W3 are electrically insulated from each other through the first insulation layer I1. Furthermore, in the first stranded wire layer W1, each of the strands S is covered by a second insulation layer I2, such that the strands S are electrically insulated from each other through the second insulation layer I2. It should be noted that a nylon wire may be disposed at the center of the multi-stranded insulated wire W.

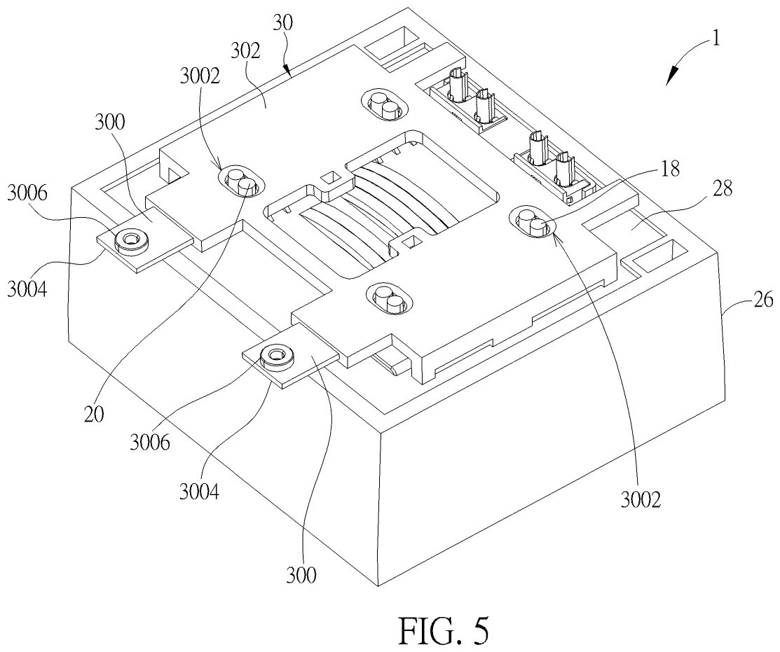

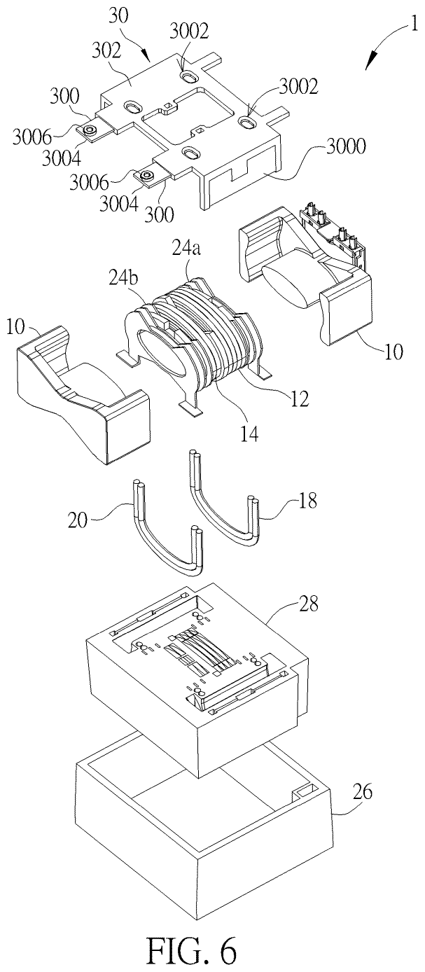

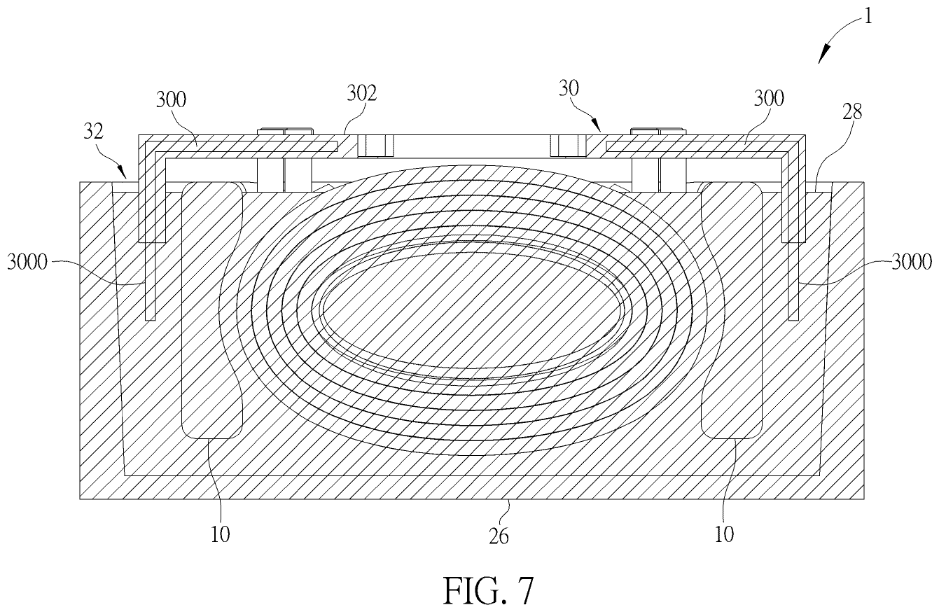

Referring to FIGS. 5 to 7, FIG. 5 is a perspective view illustrating the magnetic component 1 according to another embodiment of the invention, FIG. 6 is an exploded view illustrating the magnetic component 1 shown in FIG. 5, and FIG. 7 is a sectional view illustrating the magnetic component 1 shown in FIG. 5.

As shown in FIGS. 5 to 7, in addition to the aforesaid components, the magnetic component 1 may further comprise a casing 26, a thermal conductive filler 28 and an electric conductive member 30. The core 10 is disposed in the casing 26. In this embodiment, the core 10 may be, but is not limited to, an EE-core. The core 10 may also be a UUI-core or other types of cores according to practical applications. The thermal conductive filler 28 is filled into the casing 26, such that the thermal conductive filler 28 covers at least a part of the inner leg 100 of the core 10 and at least a part of the primary winding 12, the secondary winding 14, the first tertiary winding 18 and the second tertiary winding 20, so as to increase heat dissipation path. A material of the thermal conductive filler 28 may comprise epoxy, silicone, polyurethane (PU), phenolic resins, thermoplastic polyethylene terephthalate (PET), polyamide (PA), polyphenylene sulfide (PPS), polyetheretherketone (PEEK) and so on.

As shown in FIG. 6, the primary winding 12, the secondary winding 14, the first tertiary winding 18 and the second tertiary winding 20 may be wound around the bobbins 24a, 24b first and then assembled with the core 10, wherein the first distance d1, the second distance d2, the third distance d3 and the fourth distance d4 (as shown in FIG. 3) between the primary winding 12, the secondary winding 14, the first tertiary winding 18 and the second tertiary winding 20 may be adjusted by the thickness of the bobbins 24a, 24b.

The electric conductive member 30 is disposed above an opening 32 of the core 10 and the casing 26. In this embodiment, the electric conductive member 30 may comprise two conductive metals 300 covered by an insulation material 302. The first tertiary winding 18 and the second tertiary winding 20 are connected to the electric conductive member 30, and a part of the electric conductive member 30 is bent into the thermal conductive filler 28 for heat dissipation. In this embodiment, the two conductive metals 300 are oppositely disposed at two sides of the core 10 and are not in contact with the core 10 and the casing 26, as shown in FIG. 7. Furthermore, two bending structures 3000 of the two conductive metals 300 located outside the core 10 extend to the thermal conductive filler 28, and the two bending structures 3000 are not in contact with the core 10 and do not extend to a bottom of the casing 26. The end portions of the first tertiary winding 18 and the second tertiary winding 20 extend to the opening 32 of the core 10 and the casing 26 and are connected to a plurality of engaging holes 3002 of the two conductive metals 300, such that the first tertiary winding 18 and the second tertiary winding 20 are connected in parallel. Furthermore, two horizontal structures 3004 of the two conductive metals 300 extend out of the insulation material 302 to form two electrodes 3006 for the first tertiary winding 18 and the second tertiary winding 20. The two electrodes 3006 may be fixed to a system board (not shown) by screws, so as to electrically connect the first tertiary winding 18 and the second tertiary winding 20 to the system board.

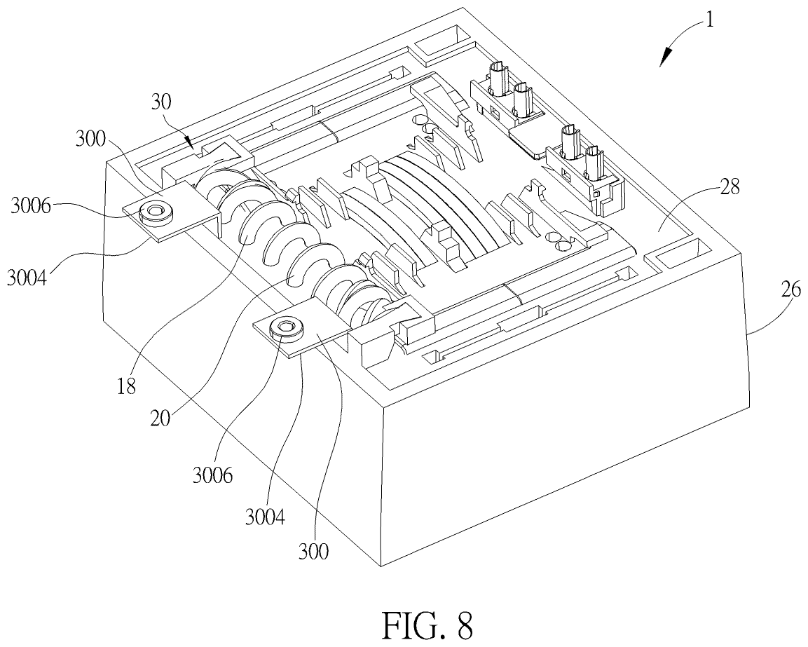

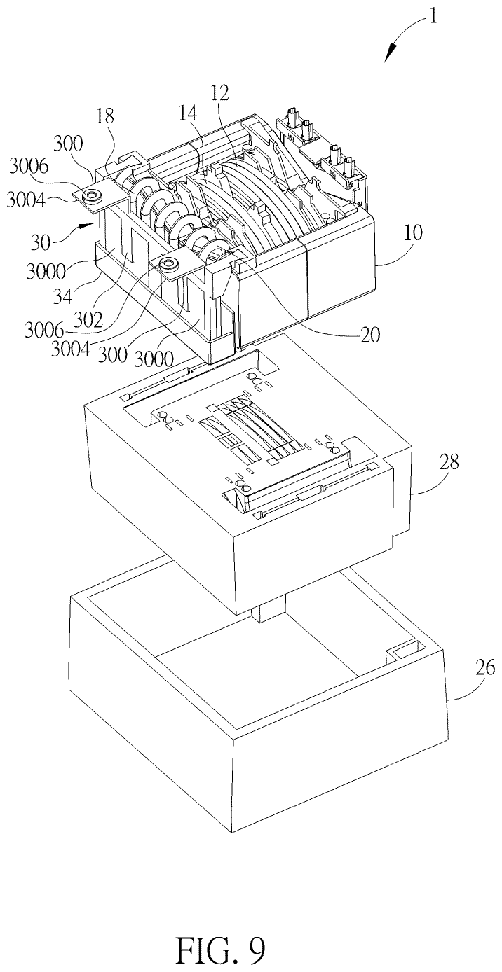

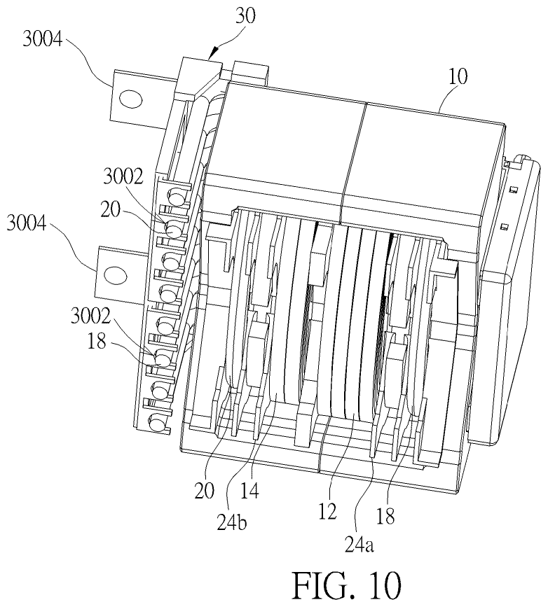

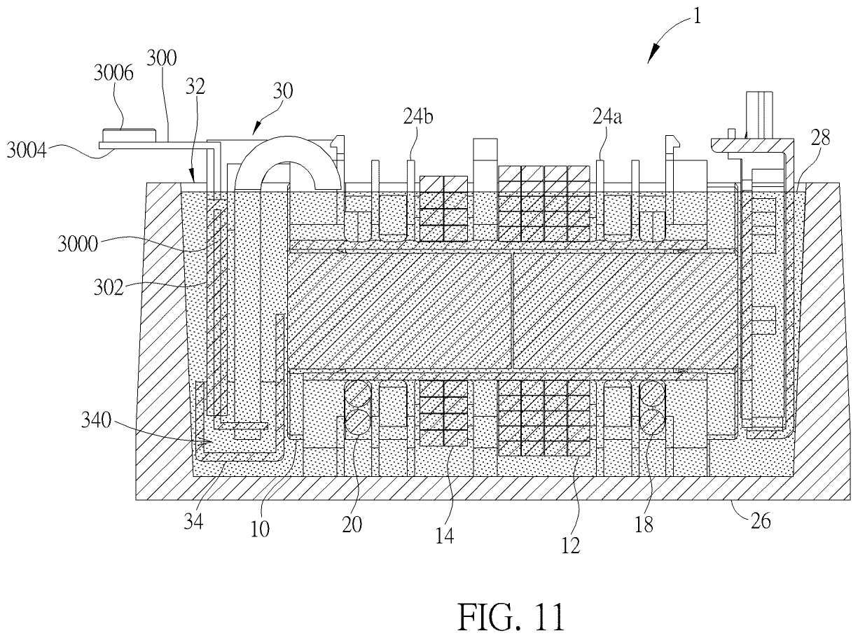

Referring to FIGS. 8 to 11, FIG. 8 is a perspective view illustrating the magnetic component 1 according to another embodiment of the invention, FIG. 9 is an exploded view illustrating the magnetic component 1 shown in FIG. 8, FIG. 10 is a perspective view of partial components shown in FIG. 9 from another viewing angle, and FIG. 11 is a sectional view illustrating the magnetic component 1 shown in FIG. 8.

The main difference between the magnetic component 1 shown in FIGS. 8 to 11 and the magnetic component 1 shown in FIGS. 5 to 7 is the arrangement of the electric conductive member 30. As shown in FIGS. 8 to 11, the electric conductive member 30 is disposed beside the core 10 instead of being disposed above the opening 32 of the core 10 and the casing 26. In this embodiment, the thermal conductive filler 28 is also filled into the casing 26, such that the thermal conductive filler 28 covers at least a part of the inner leg 100 of the core 10 and at least a part of the primary winding 12, the secondary winding 14, the first tertiary winding 18 and the second tertiary winding 20, so as to increase heat dissipation path.

In this embodiment, the electric conductive member 30 may comprise two conductive metals 300 covered by an insulation material 302. The first tertiary winding 18 and the second tertiary winding 20 are connected to the electric conductive member 30, and a part of the electric conductive member 30 is covered by the thermal conductive filler 28 for heat dissipation. In this embodiment, the two conductive metals 300 are disposed side by side at a side of the core 10 and are not in contact with the core 10, as shown in FIG. 9. Furthermore, two bending structures 3000 of the two conductive metals 300 located outside the core 10 extend to the thermal conductive filler 28 and are not in contact with the core 10. The end portions of the first tertiary winding 18 and the second tertiary winding 20 extend to a bottom of the casing 26 and are connected to a plurality of engaging holes 3002 of the two conductive metals 300, such that the first tertiary winding 18 and the second tertiary winding 20 are connected in parallel. Furthermore, two horizontal structures 3004 of the two conductive metals 300 extend out of the insulation material 302 to form two electrodes 3006 for the first tertiary winding 18 and the second tertiary winding 20. The two electrodes 3006 may be fixed to a system board (not shown) by screws, so as to electrically connect the first tertiary winding 18 and the second tertiary winding 20 to the system board. In this embodiment, an insulation member 34 may be disposed at the bottom of the casing 26 and the plurality of engaging holes 3002 of the two conductive metals 300 are disposed in an accommodating space 340 of the insulation member 34, so as to increase electrical insulation between the electric conductive member 30 and the casing 26. Since the electric conductive member 30 is disposed beside the core 10, the height of the magnetic component 1 can be effectively reduced.

Furthermore, the bobbins 24a, 24b may function as spacers, and the first distance d1, the second distance d2, the third distance d3 and the fourth distance d4 (as shown in FIG. 3) between the primary winding 12, the secondary winding 14, the first tertiary winding 18 and the second tertiary winding 20 may be adjusted by the thickness of the bobbins 24a, 24b. Still further, at least one opening may be formed on the bobbins 24a, 24b between two windings, such that the thermal conductive filler 28 may be filled into the opening to improve heat dissipation.

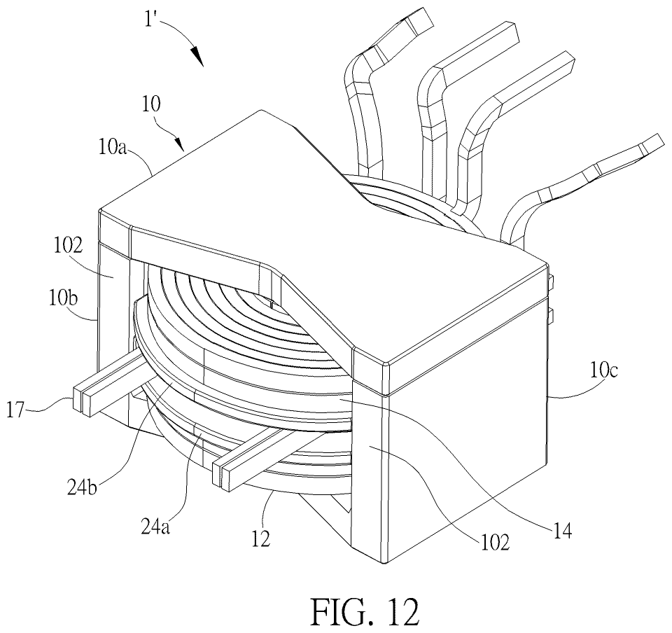

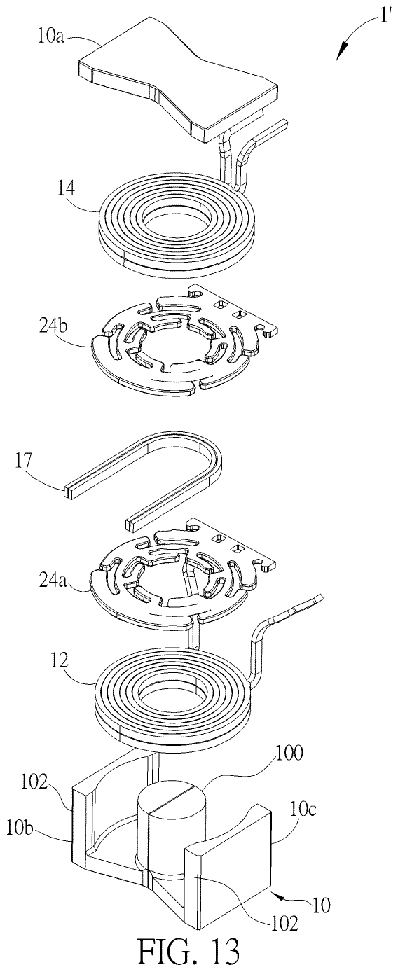

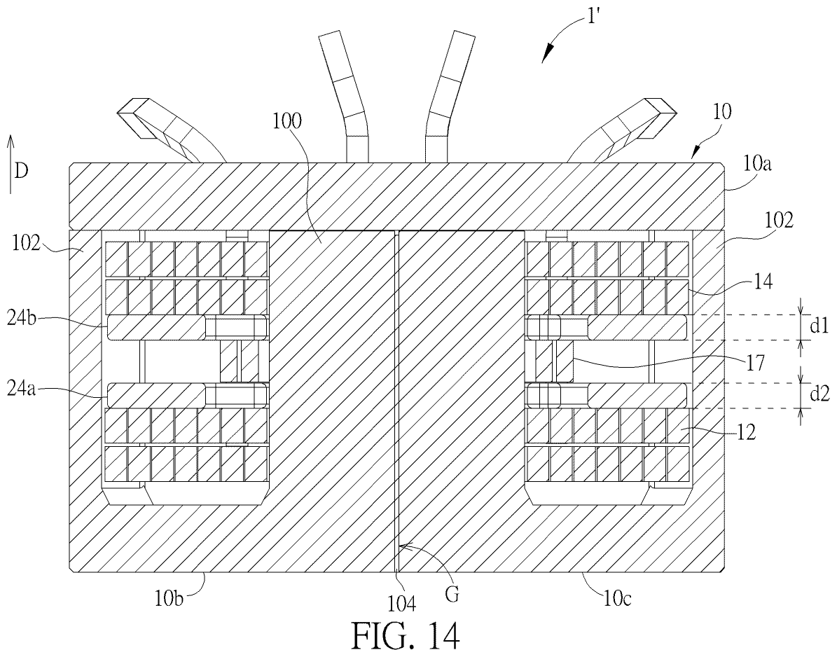

Referring to FIGS. 12 to 14, FIG. 12 is a perspective view illustrating a magnetic component 1′ according to another embodiment of the invention, FIG. 13 is an exploded view illustrating the magnetic component 1′ shown in FIG. 12, and FIG. 14 is a sectional view illustrating the magnetic component 1′ shown in FIG. 12.

The magnetic component 1′ of the invention may be a transformer or other magnetic components. As shown in FIGS. 12 to 14, the magnetic component 1′ comprises a core 10, a primary winding 12, a secondary winding 14, a tertiary winding 17 and two bobbins 24a, 24b. The primary winding 12, the secondary winding 14, the tertiary winding 17 and the two bobbins 24a, 24b are disposed in the core 10. In this embodiment, the core 10 may have an inner leg 100 and at least two outer legs 102. The primary winding 12, the secondary winding 14 and the tertiary winding 17 are wound around the inner leg 100.

The tertiary winding 17 is disposed between the primary winding 12 and the secondary winding 14, wherein the bobbin 24a is disposed between the primary winding 12 and the tertiary winding 17, and the bobbin 24b is disposed between the secondary winding 14 and the tertiary winding 17. The magnetic component 1′ is assembled by sequentially disposing the primary winding 12, the bobbin 24a, the tertiary winding 17, the bobbin 24b and the secondary winding 14 around the inner leg 100 of the core 10, so as to form a symmetrical inductance structure.

As shown in FIG. 14, the primary winding 12, the secondary winding 14 and the tertiary winding 17 may be disposed at different positions along a length direction D of the inner leg 100 without overlapping, such that each of the primary winding 12, the secondary winding 14 and the tertiary winding 17 may have a large leakage inductance.

In this embodiment, the secondary winding 14 is apart from the tertiary winding 17 by a first distance d1, and the primary winding 12 is apart from the tertiary winding 17 by a second distance d2. The first distance d1 and the second distance d2 satisfy a relationship as follows:

$$0.8 < \frac{d 2}{d 1} < 1.2 .$$

Through the relationship of the distances d1-d2 between the primary winding 12, the secondary winding 14 and the tertiary winding 17

$$( i . e . 0.8 < \frac{d 2}{d 1} < 1.2 ) ,$$

the reverse current can be eliminated and the AC loss of the tertiary winding 17 can be reduced. Furthermore, the leakage inductance error may be less than 15%, i.e. (L1−L2)/L1*100%<15%, wherein L1 represents the leakage inductance of the primary winding 12 and L2 represents the leakage inductance of the secondary winding 14. When the magnetic component 1′ is applied to a multi-port charger, the magnetic component 1′ can achieve zero voltage switching (ZVS) in both charging mode and discharging mode of the multi-port charger, such that the total loss can be reduced.

In this embodiment, a number of turns of the tertiary winding 17 may be less than a number of turns of each of the primary winding 12 and the secondary winding 14. Preferably, the number of turns of the tertiary winding 17 may be less than ½ of the number of turns of each of the primary winding 12 and the secondary winding 14.

In this embodiment, any of the primary winding 12, the secondary winding 14 and the tertiary winding 17 may be a Litz wire or a copper sheet. For example, as shown in FIG. 13, the primary winding 12, the secondary winding 14 and the tertiary winding 17 may be Litz wires, but the invention is not so limited. In general, a copper sheet has low DC loss and high AC loss, such that the magnetic component 1′ with the copper sheet may be prone to heat generation due to high AC loss. Thus, the tertiary winding 17 may be made of Litz wire to reduce AC loss.

In this embodiment, the core 10 may comprise an I-core 10a, a first U-core 10b and a second U-core 10c, as shown in FIG. 14. The first U-core 10b and the second U-core 10c are arranged side by side to provide the inner leg 100, wherein the inner leg 100 has a gap G. Furthermore, two outer legs 102 are provided by the first U-core 10b and the second U-core 10c respectively and located at opposite sides. The I-core 10a is disposed on the first U-core 10b and the second U-core 10c. A heat dissipation material 104 is filled in the gap G of the inner leg 100 to improve heat dissipation. The core 10 consisting of the I-core 10a, the first U-core 10b and the second U-core 10c can help dissipate heat and reduce core stress, so as to achieve high power density component.

It should be noted that the embodiments shown in FIGS. 4 to 11 may also be applied to the magnetic component 1′ and the repeated explanation will not be depicted herein again.

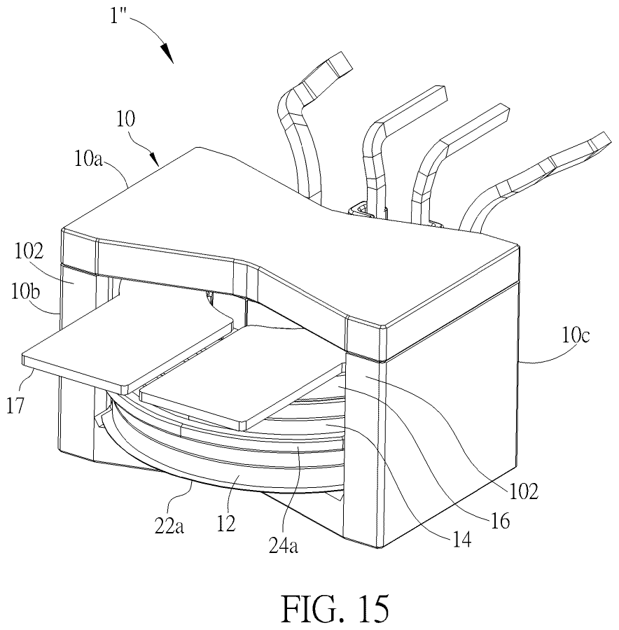

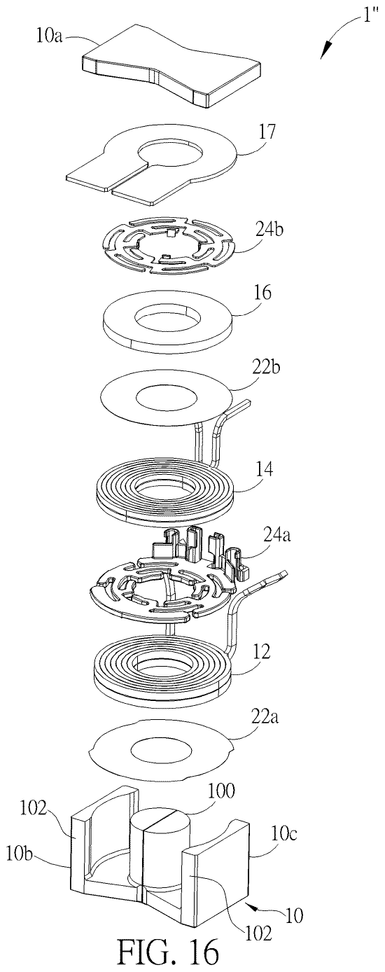

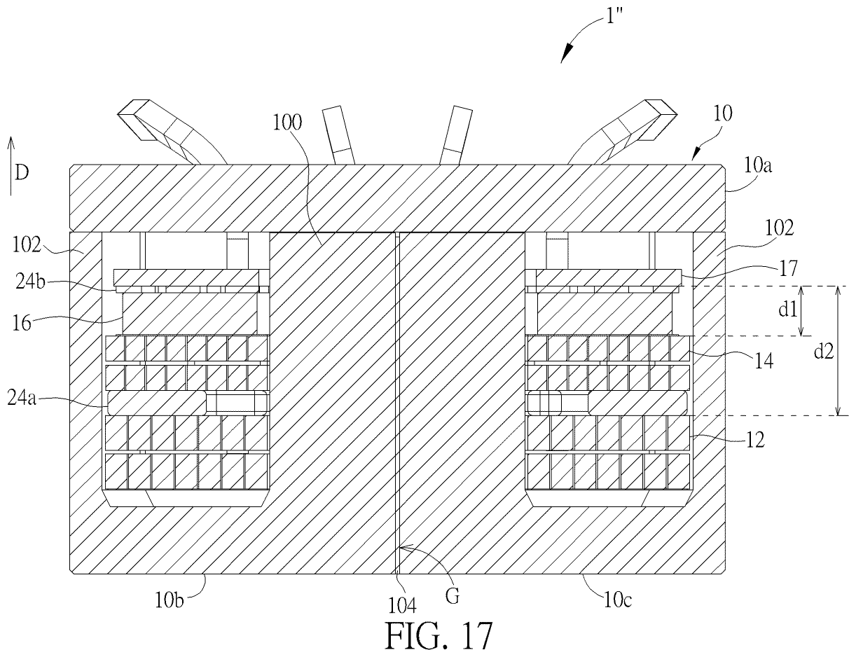

Referring to FIGS. 15 to 17, FIG. 15 is a perspective view illustrating a magnetic component 1″ according to another embodiment of the invention, FIG. 16 is an exploded view illustrating the magnetic component 1″ shown in FIG. 15, and FIG. 17 is a sectional view illustrating the magnetic component 1″ shown in FIG. 15.

The magnetic component 1″ of the invention may be a transformer or other magnetic components. As shown in FIGS. 15 to 17, the magnetic component 1″ comprises a core 10, a primary winding 12, a secondary winding 14, a magnetic member 16, a tertiary winding 17, two insulation sheets 22a, 22b and two bobbins 24a, 24b. The primary winding 12, the secondary winding 14, the magnetic member 16, the tertiary winding 17, the two insulation sheets 22a, 22b and the two bobbins 24a, 24b are disposed in the core 10. In this embodiment, the core 10 may have an inner leg 100 and at least two outer legs 102. The primary winding 12, the secondary winding 14 and the tertiary winding 17 are wound around the inner leg 100.

The secondary winding 14 is disposed between the primary winding 12 and the tertiary winding 17, wherein the bobbin 24a is disposed between the primary winding 12 and the tertiary winding 17, and the insulation sheet 22a is disposed below the primary winding 12. The magnetic member 16 is disposed between the secondary winding 14 and the tertiary winding 17, wherein the bobbin 24b is disposed between the magnetic member 16 and the tertiary winding 17, and the insulation sheet 22b is disposed between the secondary winding 14 and the magnetic member 16. The magnetic component 1″ is assembled by sequentially disposing the insulation sheet 22a, the primary winding 12, the bobbin 24a, the secondary winding 14, the insulation sheet 22b, the magnetic member 16, the bobbin 24b and the tertiary winding 17 around the inner leg 100 of the core 10, so as to form an asymmetrical inductance structure.

As shown in FIG. 17, the primary winding 12, the secondary winding 14 and the tertiary winding 17 may be disposed at different positions along a length direction D of the inner leg 100 without overlapping, such that each of the primary winding 12, the secondary winding 14 and the tertiary winding 17 may have a large leakage inductance.

In this embodiment, the secondary winding 14 is apart from the tertiary winding 17 by a first distance d1, and the primary winding 12 is apart from the tertiary winding 17 by a second distance d2. The first distance d1 and the second distance d2 satisfy a relationship as follows:

$$0 < \frac{d 1}{d 2} < 1.2 .$$

Preferably, the first distance d1 and the second distance d2 may satisfy a relationship as follows:

$$0 < \frac{d 1}{d 2} < 0.9 .$$

Through the relationship of the distances d1-d2 between the primary winding 12, the secondary winding 14 and the tertiary winding 17

$$( i . e . 0 < \frac{d 1}{d 2} < 1.2$$

or, preferably,

$$0 < \frac{d 1}{d 2} < 0 \text{.9} ) ,$$

the leakage inductance can be adjusted more flexibly and the tolerance can be stabilized. When the magnetic component 1″ is applied to a multi-port charger, the couple energy of high-voltage port and low-voltage port can be reduced to, for example, 0.15 kW (i.e. couple energy <0.15 kW) in both charging mode and discharging mode of the multi-port charger.

In this embodiment, a number of turns of the tertiary winding 17 may be less than a number of turns of each of the primary winding 12 and the secondary winding 14. Preferably, the number of turns of the tertiary winding 17 may be less than ½ of the number of turns of each of the primary winding 12 and the secondary winding 14.

In this embodiment, any of the primary winding 12, the secondary winding 14 and the tertiary winding 17 may be a Litz wire or a copper sheet. For example, as shown in FIG. 16, the primary winding 12 and the secondary winding 14 may be Litz wires, and the tertiary winding 17 may be a copper sheet, but the invention is not so limited. In general, the copper sheet has low DC loss and high AC loss, such that the magnetic component 1″ with the copper sheet may be prone to heat generation due to high AC loss. Thus, the tertiary winding 17 may be made of Litz wire to reduce AC loss.

In this embodiment, the core 10 may comprise an I-core 10a, a first U-core 10b and a second U-core 10c, as shown in FIG. 17. The first U-core 10b and the second U-core 10c are arranged side by side to provide the inner leg 100, wherein the inner leg 100 has a gap G. Furthermore, two outer legs 102 are provided by the first U-core 10b and the second U-core 10c respectively and located at opposite sides. The I-core 10a is disposed on the first U-core 10b and the second U-core 10c. A heat dissipation material 104 is filled in the gap G of the inner leg 100 to improve heat dissipation. The core 10 consisting of the I-core 10a, the first U-core 10b and the second U-core 10c can help dissipate heat and reduce core stress, so as to achieve high power density component.

It should be noted that the embodiments shown in FIGS. 4 to 11 may also be applied to the magnetic component 1″ and the repeated explanation will not be depicted herein again.

As mentioned in the above, in an embodiment, the magnetic member may be disposed between the primary winding and the secondary winding, and the first tertiary winding and the second tertiary winding may be disposed outside the primary winding and the secondary winding, so as to form a symmetrical inductance structure. Through the relationship of the distances between the primary winding, the secondary winding, the first tertiary winding and the second tertiary winding

$$( i . e . 0.8 < \frac{d 1 + d 2}{d 3 + d 4} < 1 \text{.2} ) ,$$

the leakage inductance can be balanced, the tolerance can be stabilized, and the total loss can be reduced. In another embodiment, the tertiary winding may be disposed between the primary winding and the secondary winding to form a symmetrical inductance structure. Through the relationship of the distances between the primary winding, the secondary winding and the tertiary winding

$$( i . e . 0.8 < \frac{d 2}{d 1} < 1.2 ) ,$$

the reverse current can be eliminated, the AC loss of the tertiary winding can be reduced, and the total loss can be reduced. In another embodiment, the secondary winding may be disposed between the primary winding and the tertiary winding, and the magnetic member may be disposed between the secondary winding and the tertiary winding, so as to form an asymmetrical inductance structure. Through the relationship of the distances between the primary winding, the secondary winding and the tertiary winding

$$( i . e . 0 < \frac{d 1}{d 2} < 1.2$$

or, preferably,

$$0 < \frac{d 1}{d 2} < 0 \text{.9} ) ,$$

the leakage inductance can be adjusted more flexibly, the tolerance can be stabilized, and the couple energy can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A magnetic component comprising:
a core;
a primary winding disposed in the core;
a secondary winding disposed in the core;
a magnetic member disposed between the primary winding and the secondary winding;
a first tertiary winding disposed outside the primary winding; and
a second tertiary winding disposed outside the secondary winding;
wherein the secondary winding is apart from the second tertiary winding by a first distance d1, the secondary winding is apart from the first tertiary winding by a second distance d2, the primary winding is apart from the first tertiary winding by a third distance d3, and the primary winding is apart from the second tertiary winding by a fourth distance d4;
wherein the first distance d1, the second distance d2, the third distance d3 and the fourth distance d4 satisfy a relationship as follows:
$$0.8 < \frac{d 1 + d 2}{d 3 + d 4} < 1.2 .$$

2. The magnetic component of claim 1, wherein the core has an inner leg; wherein the primary winding, the secondary winding, the first tertiary winding and the second tertiary winding are disposed at different positions along a length direction of the inner leg without overlapping.

3. The magnetic component of claim 1, wherein a number of turns of each of the first tertiary winding and the second tertiary winding is less than a number of turns of each of the primary winding and the secondary winding.

4. The magnetic component of claim 3, wherein the number of turns of each of the first tertiary winding and the second tertiary winding is less than ½ of the number of turns of each of the primary winding and the secondary winding.

5. The magnetic component of claim 1, wherein at least one of the primary winding, the secondary winding, the first tertiary winding and the second tertiary winding is wound by a multi-stranded insulated wire.

6. The magnetic component of claim 5, wherein the multi-stranded insulated wire comprises a plurality of stranded wire layers, each of the plurality of stranded wire layers is covered by a first insulation layer, a first stranded wire layer of the plurality of stranded wire layers comprises a plurality of strands, and each of the plurality of strands is covered by a second insulation layer.

7. The magnetic component of claim 1, wherein any of the primary winding, the secondary winding, the first tertiary winding and the second tertiary winding is a Litz wire or a copper sheet.

8. The magnetic component of claim 1, wherein the core comprises an I-core, a first U-core and a second U-core, the first U-core and the second U-core are arranged side by side to provide an inner leg, a heat dissipation material is filled in a gap of the inner leg, and the I-core is disposed on the first U-core and the second U-core.

9. The magnetic component of claim 1, wherein the core has an inner leg and at least two outer legs; wherein the primary winding, the secondary winding, the first tertiary winding and the second tertiary winding are wound around the inner leg.

10. The magnetic component of claim 1, further comprising:
a casing, the core being disposed in the casing;
a thermal conductive filler filled into the casing, the thermal conductive filler covering at least a part of an inner leg of the core and at least a part of the primary winding, the secondary winding, the first tertiary winding and the second tertiary winding; and
an electric conductive member disposed above an opening of the core and the casing, the electric conductive member comprising two conductive metals covered by an insulation material;
wherein the first tertiary winding and the second tertiary winding are connected to the electric conductive member, and a part of the electric conductive member is bent into the thermal conductive filler.

11. The magnetic component of claim 10, wherein the two conductive metals are oppositely disposed at two sides of the core and are not in contact with the core and the casing; wherein two bending structures of the two conductive metals located outside the core extend to the thermal conductive filler, and the two bending structures are not in contact with the core and do not extend to a bottom of the casing.

12. The magnetic component of claim 1, further comprising:
a casing, the core being disposed in the casing;
a thermal conductive filler filled into the casing, the thermal conductive filler covering at least a part of an inner leg of the core and at least a part of the primary winding, the secondary winding, the first tertiary winding and the second tertiary winding; and
an electric conductive member disposed beside the core, the electric conductive member comprising two conductive metals covered by an insulation material;
wherein the first tertiary winding and the second tertiary winding are connected to the electric conductive member, and a part of the electric conductive member is covered by the thermal conductive filler.

13. The magnetic component of claim 12, wherein the two conductive metals are disposed side by side at a side of the core and are not in contact with the core; wherein two bending structures of the two conductive metals located outside the core extend to the thermal conductive filler and are not in contact with the core; wherein the first tertiary winding and the second tertiary winding extend to a bottom of the casing and are connected to a plurality of engaging holes of the two conductive metals, such that the first tertiary winding and the second tertiary winding are connected in parallel; wherein two horizontal structures of the two conductive metals extend out of the insulation material to form two electrodes for the first tertiary winding and the second tertiary winding; wherein an insulation member is disposed at the bottom of the casing and the plurality of engaging holes of the two conductive metals are disposed in an accommodating space of the insulation member.

14. A magnetic component comprising:
a core;
a primary winding disposed in the core;
a secondary winding disposed in the core; and
a tertiary winding disposed between the primary winding and the secondary winding;
wherein the secondary winding is apart from the tertiary winding by a first distance d1, and the primary winding is apart from the tertiary winding by a second distance d2;
wherein the first distance d1 and the second distance d2 satisfy a relationship as follows:
$$0.8 < \frac{d 2}{d 1} < 1.2 .$$

15. The magnetic component of claim 14, wherein the core has an inner leg; wherein the primary winding, the secondary winding and the tertiary winding are disposed at different positions along a length direction of the inner leg without overlapping.

16. The magnetic component of claim 14, wherein a number of turns of the tertiary winding is less than a number of turns of each of the primary winding and the secondary winding.

17. The magnetic component of claim 16, wherein the number of turns of the tertiary winding is less than ½ of the number of turns of each of the primary winding and the secondary winding.

18. The magnetic component of claim 14, wherein at least one of the primary winding, the secondary winding and the tertiary winding is wound by a multi-stranded insulated wire.

19. The magnetic component of claim 18, wherein the multi-stranded insulated wire comprises a plurality of stranded wire layers, each of the plurality of stranded wire layers is covered by a first insulation layer, a first stranded wire layer of the plurality of stranded wire layers comprises a plurality of strands, and each of the plurality of strands is covered by a second insulation layer.

20. The magnetic component of claim 14, wherein any of the primary winding, the secondary winding and the tertiary winding is a Litz wire or a copper sheet.

21. The magnetic component of claim 14, wherein the core comprises an I-core, a first U-core and a second U-core, the first U-core and the second U-core are arranged side by side to provide an inner leg, a heat dissipation material is filled in a gap of the inner leg, and the I-core is disposed on the first U-core and the second U-core.

22. The magnetic component of claim 14, wherein the core has an inner leg and at least two outer legs; wherein the primary winding, the secondary winding and the tertiary winding are wound around the inner leg.

23. The magnetic component of claim 14, further comprising:
a casing, the core being disposed in the casing;
a thermal conductive filler filled into the casing; and
an electric conductive member disposed above an opening of the core and the casing;
wherein the tertiary winding is connected to the electric conductive member, and a part of the electric conductive member is bent into the thermal conductive filler.

24. The magnetic component of claim 14, further comprising:
a casing, the core being disposed in the casing;
a thermal conductive filler filled into the casing; and
an electric conductive member disposed beside the core;
wherein the tertiary winding is connected to the electric conductive member, and a part of the electric conductive member is covered by the thermal conductive filler.

25. A magnetic component comprising:
a core;
a primary winding disposed in the core;
a tertiary winding disposed in the core;
a secondary winding disposed between the primary winding and the tertiary winding; and
a magnetic member disposed between the secondary winding and the tertiary winding;
wherein the secondary winding is apart from the tertiary winding by a first distance d1, and the primary winding is apart from the tertiary winding by a second distance d2;
wherein the first distance d1 and the second distance d2 satisfy a relationship as follows:
$$0 < \frac{d 1}{d 2} < 1.2 .$$

26. The magnetic component of claim 25, wherein the core has an inner leg; wherein the primary winding, the secondary winding and the tertiary winding are disposed at different positions along a length direction of the inner leg without overlapping.

27. The magnetic component of claim 25, wherein a number of turns of the tertiary winding is less than a number of turns of each of the primary winding and the secondary winding.
